(19) United States
(12) Patent Application Publication
(10) Pub. No.: US 2022/0198223 A1
(43) Pub. Date: Jun. 23, 2022

(54) TASK CODE RECOMMENDATION MODEL

(71) Applicant: INTUIT INC., Mountain View, CA (US)

(72) Inventors: Josue ESPINOSA GODINEZ, Nampa, ID (US); Jacob Wesley DYM, Boise, ID (US); Akshay KANSAL, Boise, ID (US); Jorge Ricardo SALAZAR RAMIREZ, Boise, ID (US); Jesse RUNDLE, Boise, ID (US); Nathan A. MCINTYRE, Meridian, ID (US)

(21) Appl. No.: 17/132,796

(22) Filed: Dec. 23, 2020

(51) Int. Cl. G06K 9/62; G06N 20/00; G06Q 10/06

(52) U.S. Cl. CPC G06K 9/6257; G06N 20/00; G06Q 10/0633; G06Q 10/06316; G06K 9/6262

(57) ABSTRACT

Certain aspects of the present disclosure provide techniques for generating a recommendation of task codes for a user of a task management application. A machine learning model is trained on historical data, which includes task code histories of users and corresponding location data of computing devices the user is accessing. The trained model generates a set of predicted task codes and a respective probability indicating the likelihood a user will select the task code. A subset of task codes are identified, for example, that meet or exceed a probability threshold value. The subset of task codes are included in a recommendation displayed in the application to the user. The selection of a task code by a user not only is included in that user's task code history but is also indicative of feedback for the trained model for further training.

### INTRODUCTION

Aspects of the present disclosure relate to generating a task code recommendation for a user of an application.

### BACKGROUND

Organizations, such as businesses (e.g., for profit, non-profit, etc.), governing authorities (e.g., country, state, county, city, etc.), and other such entities often implement various types of applications to support internal and/or external operations of the organization. One such type of application that organizations implement is task management applications. A task management application is a software program product designed to track the amount of time a user (e.g., an employee, volunteer, etc.) of an organization has spent working on a task and/or which task(s) the user has worked on.

The task management application can assist an organization for accounting and billing purposes. For example, by implementing the task management application, the organization can determine invoices to clients, payroll for employees, etc. Further, the task management application can assist an organization in managing projects. For example, by implementing the task management application, the organization can determine how many and which users are working on a certain task. In addition, the organization can determine, based on the task management application, whether to assign additional users to a task or re-assign current users to other tasks.

While the task management application can support an organization in various different operations, task management applications have a number of shortcomings. For example, a task management application can strain resources for an organization as it takes time for a user to look up specific task codes. Further, the time spent entering task code information into a task management application could be spent on other tasks. Another shortcoming of task management applications is that such applications are often backward looking, for example, focusing on keeping track of task codes previously used, but fail to consider or accurately consider upcoming task code usage.

Therefore, a solution is needed that can overcome the shortcomings of conventional task code management applications.

### BRIEF SUMMARY

Certain embodiments provide a method, for example, to generate a predicted task code recommendation for a user based on a trained task code recommendation model. The method includes receiving a request for a task code recommendation based on a user accessing an application account on a computing device. The method further includes upon receiving the request for the task code recommendation, retrieving input data corresponding to the user, wherein the input data includes a task code history and location data. The method further includes generating a data array based on the input data. The method further includes inputting the data array of the input data to a trained machine learning model to predict a set of task codes for the task code recommendation. The method further includes generating via the trained machine learning model the prediction of the set of task codes for the task code recommendation, wherein the prediction includes a corresponding probability value for each task code in the set of task codes. The method further includes determining a subset of task codes from the set of task codes that meet a probability threshold value. The method further includes transmitting the subset of task codes as the task code recommendation for display on the computing device for the user.

Certain embodiments provide a method, for example, of a computing device to generate a predicted task code recommendation for a user. The method comprises receiving a request for a task code recommendation based on a user accessing an application account on a computing device, wherein the computing device includes a cached machine learning model for generating the task code recommendation. The method further includes upon receiving the request, retrieving input data for input to the cached machine learning model. The method further includes generating via the cached machine learning model a prediction of a set of task codes for the task code recommendation based on the input data, wherein the prediction includes a corresponding probability value for each task code in the set of task codes. The method further includes determining a subset of task codes from the set of task codes that meet a probability threshold value. The method further includes displaying the subset of task codes from the set of task codes on the computing device.

Other embodiments provide systems to perform the aforementioned methods associated with generating a task code recommendation for a user. Additionally, other embodiments provide non-transitory computer-readable storage mediums comprising instructions for performing the aforementioned methods.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example computing environment, according to an embodiment.

FIG. 2 depicts an example flow diagram of training a model to generate a predicted task code, according to an embodiment.

FIG. 3 depicts an example user interface displaying the predicted task code recommendation, according to an embodiment.

FIG. 4 depicts an example method of generating a task code recommendation, according to an embodiment.

FIG. 5 depicts an example method of generating a task code recommendation, according to an embodiment.

FIG. 6 depicts an example server, according to an embodiment.

FIG. 7 depicts an example computing device, according to an embodiment.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for generating a task code recommendation via a trained model.

In order to generate a task code recommendation, a machine learning model is trained on historical training data. The historical training data can include historical task code history of each user of a task management application, the respective historical location data of the user, and the selected task code corresponding to the user. In some cases, the historical training data can include historical input parameter data including age of user accounts, age of task codes, location(s) of a user, and a frequency of task code use in a period of time. In other cases, more or fewer types of historical input parameter data can be used to train the machine learning model based on a determination of which available inputs are more predictive. The training data can also include hyperparameters and testing data for generating and training the machine learning model.

To train the machine learning model, a hyperparameter tuning algorithm (e.g., a Bayesian random search) can generate different models based on permutations of hyperparameters to determine the best performing model (e.g., the most accurate model). In some cases, for a classifier model, such as a random forest, the hyperparameters can range from the number of decision trees in the forest, the learning rate of the model, the loss function used to optimize, etc. To train each model generated by the hyperparameter tuning algorithm, the historical input parameter data is passed to the hyperparameter tuning algorithm to train and compared to testing data. Based on the training data, the machine learning model is trained to generate a prediction of task code(s) and a probability a user will select the respective task code.

Once the best performing machine learning model is generated and trained, the machine learning model is deployed in a task management application. In some cases, the task management application is a web-based application. In other cases, the task management application is a mobile application (e.g., on a computing device).

When a user accesses the task management application, the user's task code history and location information are retrieved and input to the trained model. In some cases, other types of data are input to the trained model, based on the types of historical input parameter data used to train the model. For example, an age of the account, age of task code, task code history of other users, etc., can be input to the trained model. Upon receiving input data (e.g., task code history, location data, including current and past location information, an age of the account, age of task code, etc.), the trained model then generates a prediction of the task code(s) to recommend to the user. Each task code in the prediction can include a probability value indicating the likelihood a user will select the task code. Based on the probability value of each task code, the task codes from the set of predicted task codes that meet a probability threshold value can be included in the task code recommendation displayed to the user.

Once the user selects a task code from the recommendation, the selection of the task code is saved to the user's task code history. Additionally, the selection of the task code from the recommendation signals positive feedback to the model regarding accuracy of the recommendation. The location of the user when the task code is selected is also saved in reference to the task code selected.

In some cases, the user can enter a task code not included in the recommendation of task codes. By entering a task code not in the recommendation, the entered task code is saved to the user's task code history. Further, the model can receive a signal of negative feedback for failing to accurately provide the entered task code in the recommendation. The feedback data that the model receives (e.g., positive and negative) along with updates to the user's task code history and location data assist in continued training of the model.

During deployment, the trained machine learning model is monitored for accuracy. In some cases, the machine learning model is re-trained periodically with updated training data (e.g., new task code history and location data of users). For example, the machine learning model can be re-trained on a scheduled basis after a certain duration of time has passed. The machine learning model can also be re-trained after receiving a threshold value of feedback data. In other cases, the accuracy of the machine learning model is determined based on the percentage of user selecting a task code that was recommended (e.g., positive feedback) versus the percentage of users manually entering a task code different from what was recommended to the user (e.g., negative feedback). If the value of the positive feedback falls below a threshold value or the value of the negative feedback exceeds a threshold value, then the machine learning model can be re-trained based on the updated data collected from users.

In determining task codes that meet the probability threshold value for the recommendation and continued training of the model, the task code recommendation itself can be more accurate. Further, a trained model generating the prediction of task codes for the recommendation reduces the time spent entering task code information. By taking into account task code history as well as location data, the trained model can anticipate user activity in generating the recommendation.

### Example Computing Environment

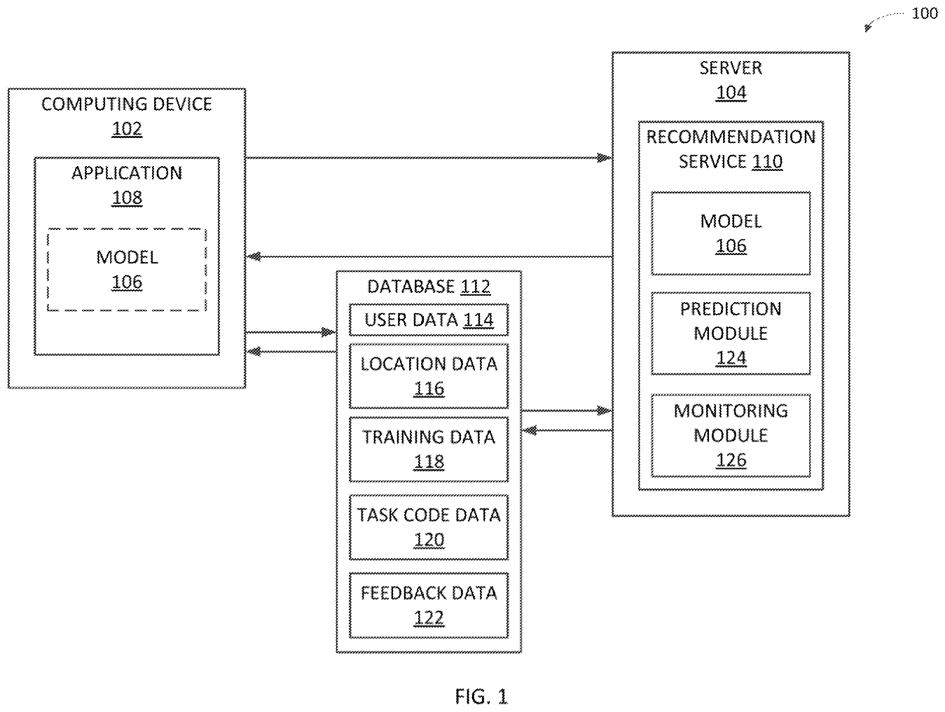

FIG. 1 depicts an example computing environment 100. As illustrated, the example computing environment 100 includes a computing device 102 and a server 104. A computing device 102 can include a computer, laptop, tablet, smart phone, or other such computing devices with the same or similar capabilities. A server 104 can be a physical server or a virtual (e.g., cloud) server.

The computing device 102 can include a task management application 108 (or application 108) for a user to interact with. In particular, the application 108 is a software program product for performing task management operations. For example, the application 108 can track job(s) completed by user(s), the amount of time spent by user(s) on a particular job, etc. In order to perform task management operations efficiently, without expending unnecessary resources, a task management application 108 can generate a recommendation of task codes for a user to select from when inputting data about tasks performed by the user, such as amount of time, description of the task, etc. To do so, a trained model 106 of the application 108 can generate a prediction of task codes along with the probability value for each task code in the prediction. The task codes with a probability value meeting a probability threshold value are determined and included in the recommendation.

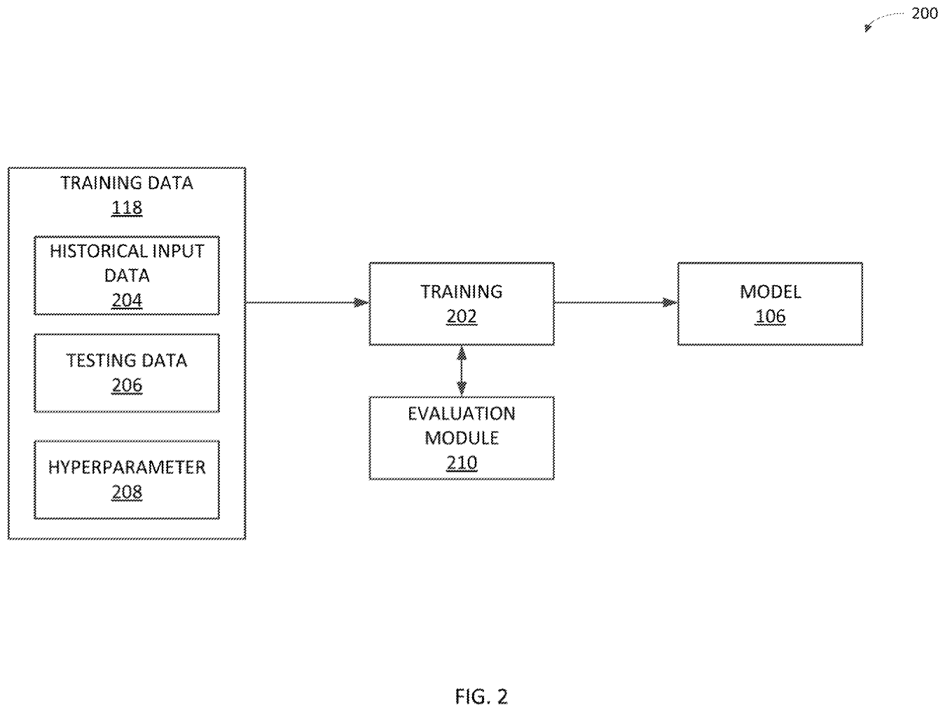

In some cases, the task management application 108 can be a web-based application. In such cases, when a user accesses the application 108 on the computing device 102 (e.g., via a web browser), a signal is triggered and sent to the server 104. The server 104 hosts a recommendation service 110 for generating a recommendation of task codes for the user. The recommendation service 110 includes: a model 106 that is trained as further described in FIG. 2, a prediction module 124, and a monitoring module 126. The model 106 can be a classifier machine learning model. For example, the model 106 can be a random forest model, a gradient boost ensemble, neural network, or any binary classifier.

Once the server 104 receives the signal from the computing device 102 that the user has accessed the application 108 (e.g., by logging into the user's account), the user's data is retrieved from a database 112. In some cases, the database 112 can be located on the server 104. In other cases, the database 112 is located remotely from the server 104 (and computing device 102).

The database 112 stores user data 114, location data 116, training data 118, and task code data 120. The user data 114 includes user's task code history, such as the frequency of task codes selected and/or entered by the user to the application 108. In some cases, the user data 114 can include a user's entire task code history (e.g., such as from when the user first started using the application 108). In other cases, the user data 114 can include a user's short-term task code history (e.g., for a recent period of time). For example, the user data 114 can include the task code history for the past two-weeks while any task code history prior to that time period are saved as part of training data 118, to train the model 106. In some cases, the user data 114 for the most recent period of time can also be stored as training data 118. The period of time can be more or less than two-weeks, depending on how the model 106 is trained to generate a prediction of task codes. The user data 114 can also include the age of a user's account.

The location data 116 includes location information of the user based on the computing device 102 the user is accessing to select and/or enter task code information to the application 108. In some cases, the location data 116 can include distance of a user relative to location associated with a task. Similar to the user data 114, the location data 116 can include a user's entire history of location information when interacting with the application 108 or for a recent period of time. In the case where location data 116 includes location information for a recent period of time, any location data 116 collected prior to the recent period of time can be saved as training data 118. In some cases, the training data 118 can include the location data 116 collected in the recent period of time. The training data 118 is a collection of previously collected user data 114 (e.g., user task code history and user account age) and location data 116 that trains (and continues to train) the model 106 with the latest information.

The training data 118 can include historical input parameter data, testing data, and hyperparameters. For example, the historical input parameter data of the training data 118 can include previously collected user data (e.g., task code history and age of user's account), location data, and task code data. The historical input parameter data can include other types of input parameter data that can predict the task code of a user. For example, other types of input parameter data can include the task code history of other users of the application, user schedules, etc. The type of input parameter data for training a model is based on the predictive nature of the type of input parameter (e.g., is the type of input parameter likely to predict the task code for the user?).

The training data 118 can be used during model training by a hyperparameter tuning algorithm (e.g., a Bayesian random search). The hyperparameter tuning algorithm can generate variations of a model based on hyperparameters and train each model based on the historical types of input parameter data (e.g., previously collected user data, location data, etc.). During training, the results generated by each model variation are compared to the testing data to determine the optimal model to generate a predicted task code. In some cases, the optimal model is the model trained with training data 118 that has the highest accuracy in generating the prediction. Further, the determination of the optimal model and the corresponding permutation of hyperparameters is based on accuracy and balanced by determining the cost (e.g., resource, time, financial, etc.) associated with each permutation.

The database 112 can also include task code data 120, which is data associated with the task code(s) of the application. The task code data 120 can include a task code identifier, a description of the task code, age of task code, location of the task associated with the task code, etc. In some cases, the age of the task code can be an input to the machine learning model along with the other inputs (e.g., user task code history, location data, and age of user account). The training data 118 can also include previously collected task code data 120.

As described above, once the server 104 receives a signal from the computing device 102 that a user has accessed the application 108, the recommendation service 110 retrieves recently stored user data 114 (e.g., user task code history and age of user account), location data 116 (e.g., location information of the user, distance of user relative to a task, etc.), and/or task code data 120 (e.g., age of a task code, location of task, etc.), based on the training of the model 106. In some cases, the recommendation service 110 can retrieve user data 114, location data 116, and/or task code data 120 for the past two-weeks of the user. In other cases, the recommendation service 110 can retrieve user data 114, location data 116, and/or task code data 120 for a greater or less period of time based on the training of the machine learning model.

Once the user data 114, location data 116, and task code data 120 are retrieved, a data array is generated for input to the model 106. The model 106, upon receiving the input data array of user data 114, location data 116, and task code data 120, generates a prediction of task codes that a user may select along with a corresponding probability of the likelihood a user will select the respective task code. The model 106 is trained to generate the prediction based on at least the short-term history of task codes and location data based on the understanding that a user is likely to perform certain tasks in certain locations and that a user is likely to work on the same task in the short term.

For example, a user worked on Project A at Location B for the past three days and worked on Project C at Location D one week ago. If the model 106 receives information indicating that user is at Location D, the model 106 is likely to predict with a higher probability that the user is likely to work on Project C than Project A. In another example, if the user has worked on Project A at Locations B, E, and F every day for the past two weeks, then if user is at new Location G, the model 106 can predict the user is likely to work on Project A, given that previously the user has worked on Project A in multiple locations.

Once the model 106 generates a predicted set of task codes (e.g., corresponding to the task a user is working on), the prediction module 124 of the recommendation service 110 can receive the set of predicted task codes. In some cases, the prediction module 124 determines which task codes in the set of predicted task codes have a probability value greater than a threshold value. In other cases, the prediction module 124 ranks the set of predicted task codes based on probability and selects the top group of task codes. For example, the prediction module 124 can select the top 3 task codes (but is not limited to this selection and can select more or less than 3 task codes with high probability). In doing so, the recommendation service 110 can generate a recommendation with a greater degree of accuracy and at the same time, without overwhelming the user with task codes that have low probability. After the prediction module 124 determines a subset of predicted task codes from the set of predicted task codes, the recommendation service 110 can generate the recommendation to display on the computing device 102.

In some cases, the task management application 108 can be a mobile application 108 that includes a local, cached model 106 on the computing device 102. To reduce the amount of resources expended in generating a recommendation for the user, a model 106 can be trained on the server 104 based on training data 118 and an instance of the model 106 can be cached locally on the computing device 102. For example, in the case where the application 108 includes a cached model 106 on the computing device 102, the application 108 can retrieve the user data 114, location data 116, and task code data 120 from the database 112. In some cases, the user data 114 and location data 116 can be stored locally on the computing device 102. In such cases, the application 108 does not have to retrieve the user data 114 or location data 116 from an external data source (e.g., database 112 that is located remotely from the computing device 102).

The cached model 106 can generate a set of predicted task codes, which the mobile application 108 can review to determine a subset of predicted task codes from the set of predicted task codes for the recommendation. As described above, the subset of predicted task codes can either meet a probability threshold value and/or are the highest ranking group of predicted task codes in the subset of predicted task codes. Such determined subset of task codes are recommended to the user for selection.

After a recommendation is presented to the user, the application 108 can receive a selection of a task code. The selection of a task code is saved in the user data 114. Additionally, the location of the user is also saved in location data 116 corresponding to the selection of a task code. Further, the selection of a task code can also be feedback data 122 for the monitoring module 126 of the recommendation service 110. The monitoring module 126 determines the accuracy of the model 106 based on the feedback data 122 received from the application 108 from all users.

Positive feedback data is when the user selects a task code from the recommendation generated. Negative feedback data is when a user does not select a task code from the recommendation generated and instead manually enters a task code that was not recommended. The monitoring module 126 monitors feedback data 122 generated to maintain model 106 accuracy. If the accuracy percentage falls below an accuracy threshold, the monitoring module 126 can signal re-training of the model 106 outside of any periodic or scheduled re-training. For example, if the percentage of positive feedback falls below a certain threshold value or the percentage of negative feedback exceeds a certain threshold value, the model 106 can be retrained.

### Example of Training a Model to Generate a Predicted Task Code

FIG. 2 depicts an example diagram 200 of training a model 106 to generate a predicted task code.

The model 106 is initially trained prior to implementation in a task management application, as described above in FIG. 1. The model 106 is trained 202 using training data 118 that includes historical data collected from (and authorized by) users of the task management application. The trained model 106 can be a random forest model or other type of classifier machine learning model. With a random forest algorithm for training 202 the model 106, the predicted task code and an estimate is determined of the probability the predicted task code will be selected.

The training data 118 can include (e.g., as input parameters for training the model 106) historical input data 204 such as age of user account, age of task code, location of users, and a frequency of task code use in a period of time by the users. In some cases, the frequency of task code use can be for a period of the recent 14 days, but the period of time is not limited to the recent 14 days and can be more or fewer days. The training data 118 can also include testing data 206, which includes historical task codes generated for a prediction and/or entered to the application.

The training data 118 is not limited to the example types of historical input data 204 provided above and more or fewer types of parameter data can be included in the training data 118, considering on balance the accuracy and cost function of including a type of parameter data in training data 118.

For training 202 the model 106, a hyperparameter tuning algorithm can generate different models based on permutations of hyperparameters 208. For example, in a random forest model, the hyperparameters 208 can include: the number of decision trees in the forest, the learning rate of the model, the loss function used to optimize, etc. In such cases, one model permutation generated by the hyperparameter tuning algorithm can have 200 decision trees with an exponential loss function. In another example, another model permutation generated by the hyperparameter tuning algorithm can have 20 trees with a Gini loss function.

The hyperparameter tuning algorithm can train each model variation with the training data 118. In some cases, the hyperparameter tuning algorithm (e.g., a Bayesian randomized search) can train the models in batches. For training, the hyperparameter tuning algorithm can determine based on the hyperparameters 208 passed to the model which model and/or hyperparameter 208 yields accurate results and is optimal for implementation. The accuracy of a model and/or hyperparameter 208 is determined by inputting the historical input data 204 of the training data 118 to the model and comparing the results with the testing data 206 of the training data 118. In some cases, each model generated by the hyperparameter tuning algorithm with a different permutation can be evaluated via the evaluation module 210 based on available resources and accuracy level. The evaluation module 210 can include an accuracy threshold and resource threshold for determining which model has the highest accuracy given a resource threshold.

For example, the evaluation module 210 can evaluate a first model permutation that has a 90% accuracy and a second model permutation that has a 95% accuracy—both exceeding an accuracy threshold of 80%. The first model permutation may not exceed the resource threshold but the second model permutation can exceed the resource threshold. The evaluation module 210 would select first model permutation because the accuracy exceeds the accuracy threshold but does not exceed the resource threshold.

When new input parameter data is available, the hyperparameter tuning algorithm (e.g., Bayesian random search) can re-evaluate the hyperparameters 208 and determine the model 106 for predicting a task code based on the new input parameter data and identifying the best performing model. In some cases, the hyperparameter tuning algorithm can re-evaluate the hyperparameters when the accuracy of the model 106 falls below an accuracy threshold.

### Example User Interface

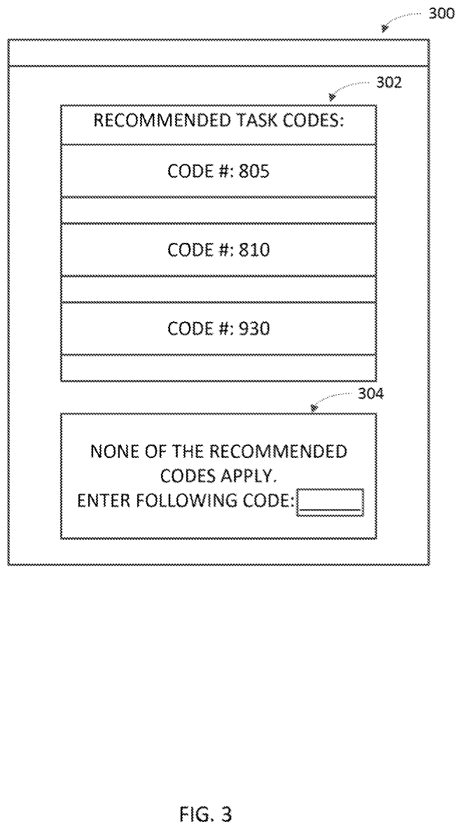

FIG. 3 depicts an example user interface 300 displayed via an application (e.g., a web-based application or a mobile application).

As illustrated, in the user interface 300, a recommendation 302 of task codes is displayed. In some cases, the recommendation 302 is displayed automatically when the user accesses the application. For example, upon logging into the user account, the recommendation is generated based on at least the user's task code history and current location of the computing device the user is accessing their account with. In other cases, the recommendation 302 is displayed based on a user selecting an option to generate the recommendation 302. For example, after the user has logged into their account, the user enter their time for a task and then select to generate the recommendation 302 to complete a task entry in the application.

The recommendation 302 is generated based on the predicted task codes. The predicted task codes is generated by the trained model. In some cases, the recommendation 302 of task codes is based on the predicted task codes that have a corresponding probability value that meets (or exceeds) a probability threshold value.

In other cases, the recommendation 302 of the task codes is based on a ranking of predicted task codes and displaying a top-X number task codes, as illustrated, where “X” is a positive, non-zero integer value. The number of task codes in the recommendation 302 is not limited to 3 task codes and can include more or less task codes, depending on the probability threshold value and/or a limit of task codes to display.

Further, as illustrated, the user interface 300 can include an option 304 for a user to manually enter a task code. For example, if the recommendation 302 of task codes does not include the task code the user wants to select, then the user can manually look up and/or enter the task code in the option 304.

### Example Method of Generating a Task Code Recommendation

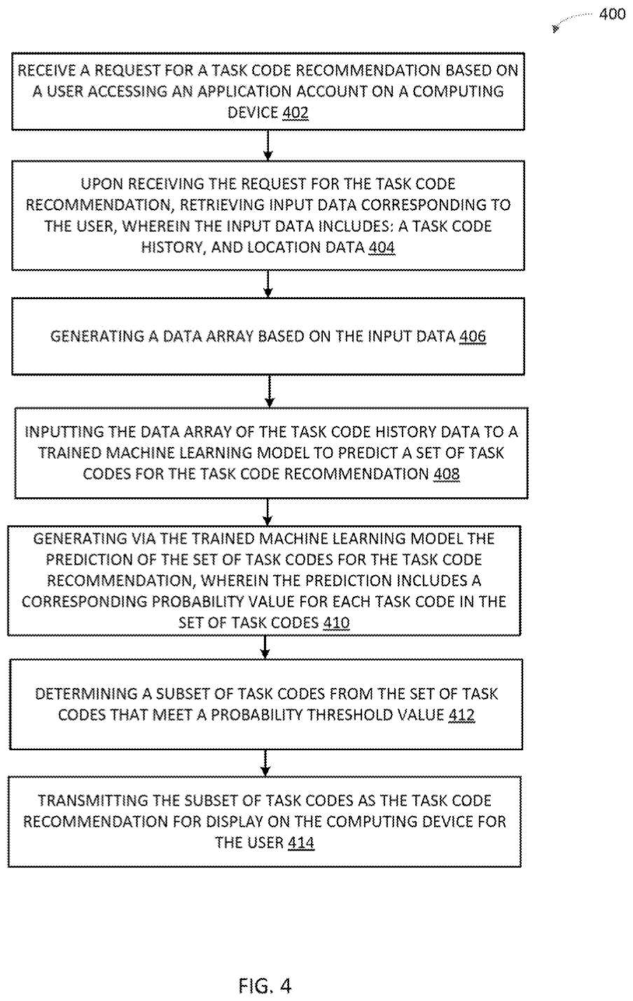

FIG. 4 depicts an example method 400 of generating recommendation of task code(s), for example, via a server.

At 402, a server receives a request for a task code recommendation based on a user accessing an application account on a computing device.

At 404, upon receiving the request for the task code recommendation, the server retrieves input data corresponding to the user, wherein the input data includes at least a task code history and location data. The task code history corresponds to the user, and the location data is associated with the computing device the user is accessing. In some cases, the input data can include age of user's account, age of task code, task code histories of other users, based on the types of training data that trained the model, as described above in FIG. 2.

At 406, the server generates a data array based on the input data.

At 408, the server inputs the data array of the input data to a trained machine learning model to predict a set of task codes for a task code recommendation.

At 410, the server generates via the trained machine learning model the prediction of the set of task codes for the task code recommendation, wherein the prediction includes a corresponding probability value for each task code in the set of task codes.

At 412, the server determines a subset of task codes from the set of task codes that meet a probability threshold value.

At 414, the server transmits the subset of task codes as the task code recommendation for display on the computing device for the user.

In some cases, once the server transmits the task code recommendation, the server can receive a selection of a task code from the task code recommendation. In such cases, the selection of the task code from the task code recommendation is positive feedback, indicating that the model is accurately generating predicted task codes. In other cases, once the server transmits the task code recommendation, the server can receive a selection of a task code not from the task code recommendation. For example, the user can enter manually a task code, which the server can receive as negative feedback data, indicating that that model failed to generate a recommendation of task codes useful to the user.

The server can monitor the model for prediction accuracy based on the positive feedback and negative feedback received. The feedback is not limited to the positive feedback and negative feedback described above. In some cases, the application the user is accessing can request feedback, for example, as comments, reviews, ratings, etc., of the application, including the recommendation generated by the model of the application.

As the server monitors the feedback received, in instances where a percentage of positive feedback from all users falls below an accuracy threshold value or a percentage of negative feedback from all users exceeds an accuracy threshold value, the server can re-train the model. In some cases, the model is re-trained with the latest task code histories and location data collected via the application. In addition to maintaining accuracy of the model by monitoring the accuracy of the predictions generated, the model is re-trained on a periodic basis. For example, the model can be re-trained every 3 months. However, the re-training is not limited to 3 months, and the model can be re-trained more or less frequently than 3 months. Additionally, the model can be re-trained based on the amount of data collected by the application. For example, if a threshold amount of data is collected regarding user task code histories and corresponding location data, then the model can be re-trained with the recently collected data. In doing so, the model can be trained on the most current data.

### Example Method of Generating a Task Code Recommendation

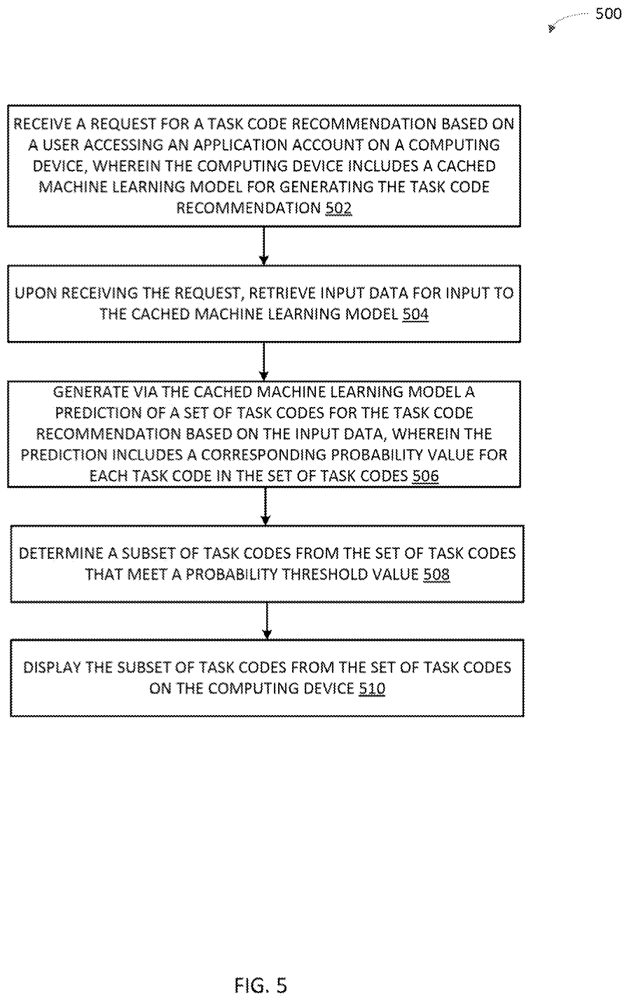

FIG. 5 depicts an example method 500 of generating recommendation of task code(s), for example, via a computing device.

At 502, a computing device receives a request for a task code recommendation based on a user accessing an application account on a computing device, wherein the computing device includes a cached machine learning model for generating the task code recommendation.

At 504, upon receiving the request, the computing device retrieves input data for input to the cached machine learning model. The input data can include time code data and location data associated with the user. Based on the training of the cached machine learning model other types of input data can be included such as an age of the account, age of task code, etc.

At 506, the computing device generates via the cached machine learning model a prediction of a set of task codes for the task code recommendation based on the input data, wherein the prediction includes a corresponding probability value for each task code in the set of task codes.

At 508, the computing device determines a subset of task codes from the set of task codes that meet a probability threshold value.

At 510, the computing device displays the subset of task codes from the set of task codes on the computing device.

### Example Server

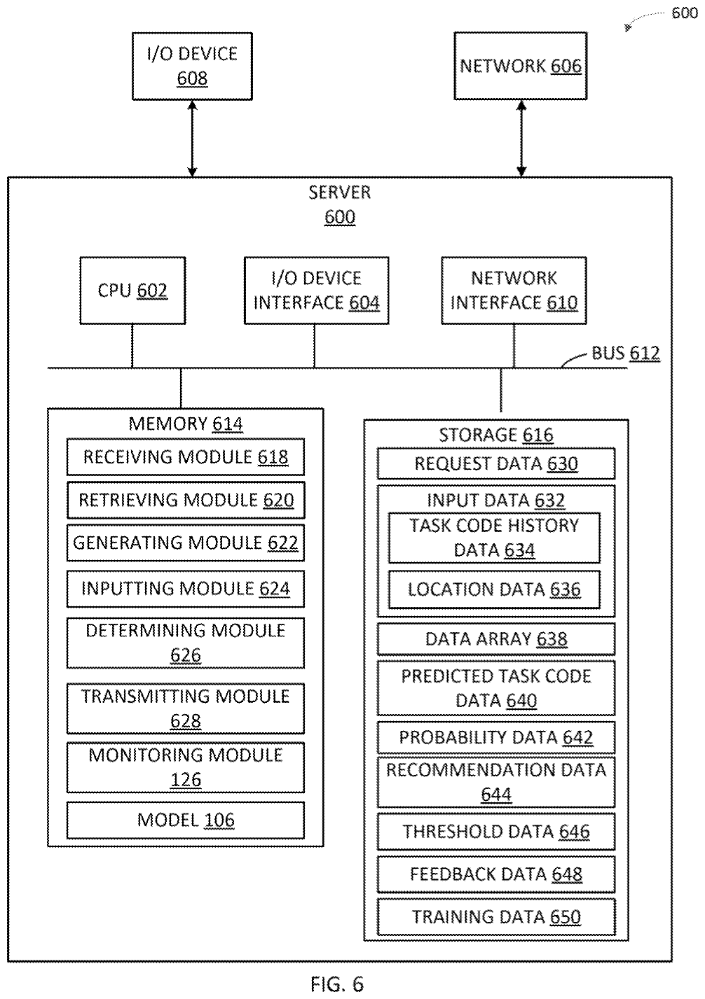

FIG. 6 depicts an example server 600 that may perform the methods described herein, for example, with respect to FIG. 4. For example, the server 600 can be a physical server or a virtual (e.g., cloud) server and is not limited to a single server that performs the methods described herein, for example, with respect to FIGS. 1, 4.

Server 600 includes a central processing unit (CPU) 602 connected to a data bus 612. CPU 602 is configured to process computer-executable instructions, e.g., stored in memory 614 or storage 616, and to cause the server 600 to perform methods described herein, for example, with respect to FIG. 4. CPU 602 is included to be representative of a single CPU, multiple CPUs, a single CPU having multiple processing cores, and other forms of processing architecture capable of executing computer-executable instructions.

Server 600 further includes input/output (I/O) device(s) 608 and interfaces 604, which allows server 600 to interface with input/output devices 608, such as, for example, keyboards, displays, mouse devices, pen input, and other devices that allow for interaction with server 600. Note that server 600 may connect with external I/O devices through physical and wireless connections (e.g., an external display device).

Server 600 further includes a network interface 610, which provides server 600 with access to external network 606 and thereby external computing devices.

Server 600 further includes memory 614, which in this example includes a receiving module 618, a retrieving module 620, a generating module 622, an inputting module 624, a determining module 626, a transmitting module 628, a monitoring module 126, and a model 106 for performing operations as described, for example, in FIGS. 1, 4.

Note that while shown as a single memory 614 in FIG. 6 for simplicity, the various aspects stored in memory 614 may be stored in different physical memories, but all accessible by CPU 602 via internal data connections such as bus 612.

Storage 616 further includes request data 630, which can include signal data received from the application, as described in FIG. 1.

Storage 616 includes input data 632, which can include user task code history data 634 and location data 636 of the computing device, as described in FIGS. 1, 4, for input to the model 106. Other types of input parameter data can include age of user account, age of task code, location of task, user schedule, task code history of other users, schedule of other users, etc., based on types of input parameter data used train the model.

Storage 616 includes a data array 638, which can include the data array of input data, as described in FIGS. 1, 4.

Storage 616 includes predicted task code data 640, which can include the predicted task codes generated by the model 106, as described in FIGS. 1, 4.

Storage 616 includes probability data 642, which can include probabilities corresponding to the predicted task code data 640, indicating a likelihood a user will select the task code, as described in in FIGS. 1, 4.

Storage 616 includes recommendation data 644, which can include a subset of task codes from the set of predicted task codes generated by the model 106 that meet a threshold probability value, as described in FIGS. 1, 4.

Storage 616 includes threshold data 646, which can include threshold values for determining a recommendation and threshold values for determining an accuracy of the model 106, as described in FIGS. 1, 4.

Storage 616 includes feedback data 648, which can include feedback data 120 as described in FIG. 1. The feedback data 648 can include an indication of a selection of task code from a recommendation (e.g., positive feedback) and/or a user entering a task code not in the recommendation (e.g., negative feedback), as described in FIGS. 1, 4.

Storage 616 can include training data 650, which can include predicted, recommended, selected, and/or entered task code data of a user, location data, other input parameters, hyperparameters, testing data, etc., as described in FIGS. 1, 2, 4.

While not depicted in FIG. 6, other aspects may be included in storage 616.

As with memory 614, a single storage 616 is depicted in FIG. 6 for simplicity, but various aspects stored in storage 616 may be stored in different physical storages, but all accessible to CPU 602 via internal data connections, such as bus 612, or external connections, such as network interfaces 604. One of skill in the art will appreciate that one or more elements of server 600 may be located remotely and accessed via a network 606.

### Example Computing Device

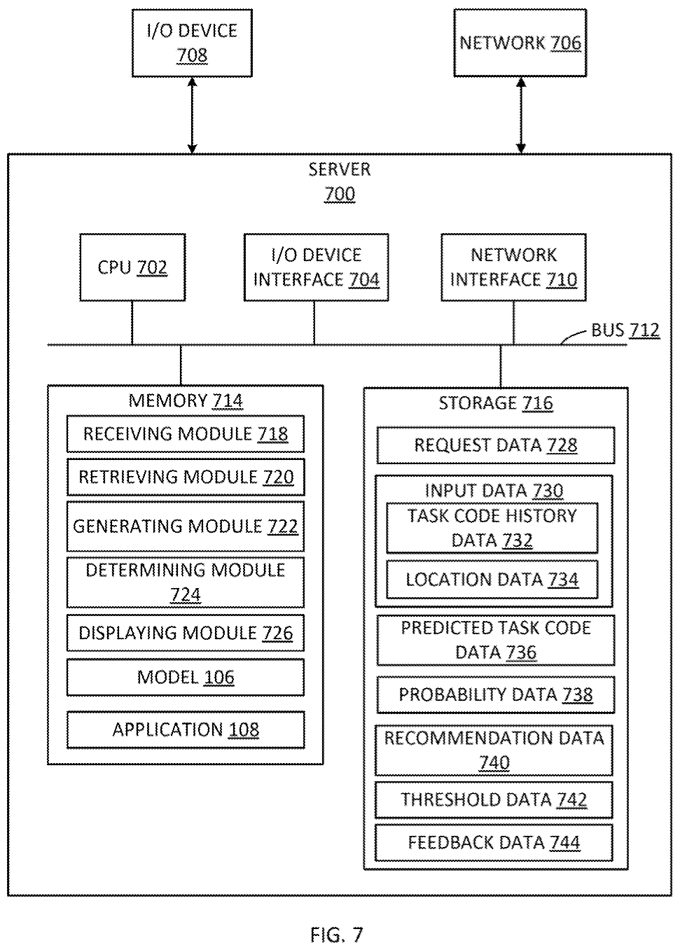

FIG. 7 depicts an example computing device 700 that may perform the methods described herein, for example, with respect to FIG. 5. For example, the computing device 700 can be a computer, laptop, tablet, smartphone, a virtual machine, or other computing device with the same or similar capabilities.

Computing device 700 includes a central processing unit (CPU) 702 connected to a data bus 712. CPU 702 is configured to process computer-executable instructions, e.g., stored in memory 714 or storage 716, and to cause the computing device 700 to perform methods described herein, for example, with respect to FIG. 5. CPU 702 is included to be representative of a single CPU, multiple CPUs, a single CPU having multiple processing cores, and other forms of processing architecture capable of executing computer-executable instructions.

Computing device 700 further includes input/output (I/O) device(s) 708 and interfaces 704, which allows computing device 700 to interface with input/output devices 708, such as, for example, keyboards, displays, mouse devices, pen input, and other devices that allow for interaction with computing device 700. Note that computing device 700 may connect with external I/O devices through physical and wireless connections (e.g., an external display device).

Computing device 700 further includes a network interface 710, which provides computing device 700 with access to external network 706 and thereby external computing devices.

Computing device 700 further includes memory 714, which in this example includes a receiving module 718, a retrieving module 720, a generating module, a determining module, a displaying module 726, a model 106, and an application 108.

Storage 716 includes request data 728, which can include signal data received by the application, as described in FIGS. 1, 5.

Storage 716 includes input data 730, which can include user task code history data 732 and location data 734, as described in FIGS. 1, 5. Other types of input parameter data can include age of user account, age of task code, user schedule, task code history of other users, schedule of other users, etc., based on types of input parameter data used train the model

Storage 716 includes predicted task code data 736, which can include the predicted task codes generated by the model 106, as described in FIGS. 1, 5.

Storage 716 includes probability data 738, which can include probabilities corresponding to the predicted task code data 736, indicating a likelihood a user will select the task code, as described in in FIGS. 1, 5.

Storage 716 includes recommendation data 740, which can include a subset of task codes from the set of predicted task codes generated by the model 106 that meet a threshold probability value, as described in FIGS. 1, 5.

Storage 716 includes threshold data 742, which can include threshold values for determining a recommendation and threshold values for determining an accuracy of the model 106, as described in FIGS. 1, 5.

Storage 716 includes feedback data 744, which can include an indication of a selection of task code from a recommendation (e.g., positive feedback) and/or a user entering a task code not in the recommendation (e.g., negative feedback), as described in FIGS. 1, 5.

While not depicted in FIG. 7, other aspects may be included in storage 716.

As with memory 714, a single storage 716 is depicted in FIG. 7 for simplicity, but various aspects stored in storage 716 may be stored in different physical storages, but all accessible to CPU 702 via internal data connections, such as bus 712, or external connections, such as network interfaces 704. One of skill in the art will appreciate that one or more elements of computing device 700 may be located remotely and accessed via a network 706.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving a request for a task code recommendation based on a user accessing an application account on a computing device;
upon receiving the request for the task code recommendation, retrieving input data corresponding to the user, wherein the input data includes:
a task code history, and
location data;
generating a data array based on the input data;
inputting the data array of the input data to a trained machine learning model to predict a set of task codes for the task code recommendation;
generating via the trained machine learning model the prediction of the set of task codes for the task code recommendation, wherein the prediction includes a corresponding probability value for each task code in the set of task codes;
determining a subset of task codes from the set of task codes that meet a probability threshold value; and
transmitting the subset of task codes as the task code recommendation for display on the computing device for the user.

2. The method of claim 1, further comprising: receiving a selection of a task code from the subset of task codes displayed to the user.

3. The method of claim 1, further comprising: receiving a selection of a task code not from the subset of task codes displayed to the user.

4. The method of claim 1, further comprising: monitoring the trained machine learning model for prediction accuracy.

5. The method of claim 4, wherein the method further comprises:
determining the prediction accuracy of the trained machine learning model is below an accuracy threshold value; and
re-training the trained machine learning model.

6. The method of claim 4, wherein the method further comprises: re-training the trained machine learning model on a periodic basis.

7. The method of claim 1, wherein the trained machine learning model is a classifier machine learning model.

8. The method of claim 1, wherein the trained machine learning model is trained based on collecting training data from a set of users, wherein the training data includes historical time code data of users comprising a number of instances a time code was selected.

9. The method of claim 8, wherein the training data includes historical location data.

10. A system, comprising:
a processor; and
a memory storing instructions, which when executed by the processor perform a method comprising:
receiving a request for a task code recommendation based on a user accessing an application account on a computing device;
upon receiving the request for the task code recommendation, retrieving input data corresponding to the user, wherein the input data includes:
a task code history, and
location data;
generating a data array based on the input data;
inputting the data array of the input data to a trained machine learning model to predict a set of task codes for the task code recommendation;
generating via the trained machine learning model the prediction of the set of task codes for the task code recommendation, wherein the prediction includes a corresponding probability value for each task code in the set of task codes;
determining a subset of task codes from the set of task codes that meet a probability threshold value; and
transmitting the subset of task codes as the task code recommendation for display on the computing device for the user.

11. The system of claim 10, wherein the method further comprises: receiving a selection of a task code from the subset of task codes displayed to the user.

12. The system of claim 10, wherein the method further comprises: receiving a selection of a task code not from the subset of task codes displayed to the user.

13. The system of claim 10, wherein the method further comprises: monitoring the trained machine learning model for prediction accuracy.

14. The method of claim 13, wherein the method further comprises:
determining the prediction accuracy of the trained machine learning model is below an accuracy threshold value; and
re-training the trained machine learning model.

15. The system of claim 13, wherein the method further comprises: re-training the trained machine learning model on a periodic basis.

16. The system of claim 10, wherein the trained machine learning model is a classifier machine learning model.

17. The system of claim 10, wherein the trained machine learning model is trained based on collecting training data from a set of users, wherein the training data includes historical time code data of users comprising a number of instances a time code was selected.

18. The system of claim 17, wherein the training data includes historical location data.

19. A method, comprising:
receiving a request for a task code recommendation based on a user accessing an application account on a computing device, wherein the computing device includes a cached machine learning model for generating the task code recommendation;
upon receiving the request, retrieving input data for input to the cached machine learning model;
generating via the cached machine learning model a prediction of a set of task codes for the task code recommendation based on the input data, wherein the prediction includes a corresponding probability value for each task code in the set of task codes;
determining a subset of task codes from the set of task codes that meet a probability threshold value; and
displaying the subset of task codes from the set of task codes on the computing device.

20. The method of claim 19, wherein the input data comprises:
time code data associated with the user; and
location data associated with user.
